(19) United States
(12) Patent Application Publication
(10) Pub. No.: US 2004/0043227 A1
(43) Pub. Date: Mar. 4, 2004

(54) Use of a polyolefin film as a medium to be written or printed on

(76) Inventors: Kart Stefan Schmitt, Dusseldorf (DE); Jorg Alois Gutowski, Munster (DE)

Correspondence Address: WILLIAM COLLARD, COLLARD & ROE, P.C., 1077 NORTHERN BOULEVARD, ROSLYN, NY, 11576, US

(21) Appl. No.: 10/399,345

(22) PCT Filed: Oct. 17, 2001
(86) PCT No.: PCT/EP01/12017

(30) Foreign Application Priority Data
Oct. 17, 2000 (DE) 100 51 495.2

(51) Int. Cl. B32B 17/10; B32B 27/00

(52) U.S. Cl. 428/441; 428/500; 428/532

(57) ABSTRACT

The invention relates to the use of a polyolefin film as a medium to be written or printed on, according to which oxygen-containing groups are attached to one or both faces of the film surface by surface treatment. The polyolefin film is then highly surface-polarized by subsequently electrostatically charging it. Film thickness and surface weight and the electrostatic adhesive force produced are controlled by the degree of surface polarization in such a manner that the film, at least when the treated face is placed on a clean, dry and planar floatglass surface, will adhere to said surface indefinitely.

The invention relates to the use of a polyolefin film as a writable or printable medium, where surface treatment has attached oxygen-containing groups, such as —OH, —COOH, or ═C═O groups, to one or both sides of the film surface.

It is known that polyethylene films can be surface-polarized by flame-treating the surface to be activated. It is also known that treatment with corona discharges can be used to modify a polyolefin surface to facilitate printing. The known processes provide surface polarization by attaching or activating the oxygen-containing groups mentioned. It is also known that this type of treated synthetic polymer film can be used for the protective covering of surfaces requiring protection, and for delimiting non-colored areas.

Another surprising application, differing from this known use of a polyolefin film, uses this type of film as a writable or printable medium. It is known that polyolefin films per se have poor writability and printability unless specific inks or the like are used. This shortcoming is eliminated by subjecting a film to the surface treatment described above. However, this type of film cannot be applied to a surface so that it adheres in the long term, as what may be called a flipchart film, unless additional adhesive compositions or adhesives are used.

The polyolefin films are to be not only writable but also adherent to a smooth or almost smooth surface, with no use of adhesive. This opens up a novel use of a polyolefin film as a writable or printable medium. Use may be made of films known per se, where surface treatment has attached oxygen-containing groups to one or both sides of the film surface, and where the polyolefin film has been strongly surface-polarized as a result of subsequent electrostatic charging, and where, for a film thickness of from 5 to 250 μm, the amount of surface polarization is such as to match the weight per unit surface area and the electrostatic adhesion generated in such a way that, at least when the treated film is applied to a clean, dry, and flat float glass surface, the films adhere to that surface in any position for an unlimited time.

An example of a method of treating a surface uses a gas flame with excess oxygen, i.e. uses substoichiometric combustion, and another method uses oxidizing surface treatment by the corona process, as described in DE-A-3537614. In the corona process, a film web is conducted through a region of arcing, where numerous small discharges provide tiny scars on the surface of the synthetic polymer, and thus at the same time modify the physical and chemical properties of the surface.

However, it has been found that this surface treatment is not generally sufficient to generate permanent electrostatic adhesion. A substantial adhesion improvement, permitting adhesion of the film for an unlimited time once applied, is achieved only by subsequent electrostatic charging. Indeed, a further increase in adhesion has been found here after the film has remained in position for a certain time (from one to 24 hours).

Additional charging is preferably reduced by an electronegative field generated, for example, by bars over which the film is conducted. However, an electropositive field has also been found to bring about a similar effect.

The amount of adhesion has to be determined empirically for a particular film. The amount of adhesion has to be at least such that, at least when the treated side of the film is applied to a clean, dry, and flat float glass surface, the film adheres to that surface, in any position, for an unlimited time. A float glass surface was selected as reference because glass has high electrical resistance. However, a slight increase in adhesion is to be expected whenever the degree of surface treatment and charging is increased. The film then adheres to painted and unpainted wood surfaces, to painted metal surfaces, to synthetic polymer films, and indeed to conducting surfaces.

Another positive effect is that when the polyolefin film has adhered it also can serve as an adherent based for the adhesive-free fixing of other light articles, such as sheets of paper, photographs, and pieces of synthetic polymer films, and can therefore also serve as what may be called a pinboard.

The film may have one or more layers. It is preferable here to use a two- to three-layered film which has been coextruded, so that the favorable character of each surface property can be maximized.

A particularly suitable polyolefin base material is polyethylene or polypropylene, in particular LDPE. The polyolefin base material may be held with one or more inorganic filler materials, these preferably having been selected from the group calcium carbonate, titanium dioxide, talc, or chalk, and admixed in a proportion of up to 45% by weight, based on the final mixture. These fillers affect transparency, but also writability and printability.

A film particularly suitable for the stated use is partially transparent, where the transparency should be from 10 to 90% (100% corresponding to complete clarity). It is particularly advantageous here for both sides of the film to have been surface-treated, one side having been printed with a grid or the like, and both sides, or only the side opposite to the print, having been subjected to additional surface-polarization by a charge. This type of film is particularly suitable as what may be called a flip-chart film, since the grid is clearly discernible and the film can in particular be applied to an illuminated window or the like.

It is clear from the description above that there is a surprising use for an electrostatically charged film, suitable film thicknesses being from 5 to 250 μm and preferably from 10 to 100 μm.

What is claimed is:

1. The use of a polyolefin film as a writable or printable medium, where surface treatment has attached oxygen-containing groups, such as —OH, —COOH, or ═C═O groups, to one or both sides of the film surface, and where the polyolefin film has been strongly surface-polarized as a result of subsequent electrostatic charging, and where, for a film thickness of from 5 to 250 μm, the amount of surface polarization is such as to match the weight per unit surface area and the electrostatic adhesion generated in such a way that, at least when the treated side is applied to a clean, dry, and flat float glass surface, the film adheres to that surface in any position for an unlimited time.

2. The use of a polyolefin film as claimed in claim 1, characterized in that when the polyolefin film has adhered it serves as an adherent base for the adhesive-free fixing of other light articles, such as sheets of paper, photographs, and pieces of synthetic polymer films.

3. A polyolefin film for the use as claimed in claim 1 or 2, characterized in that it has more than one layer.

4. A polyolefin film for the use as claimed in claim 1 or 2, characterized in that the polyolefin base material is polyethylene or polypropylene, in particular LDPE.

5. A polyolefin film for the use as claimed in claim 1 or 2, characterized in that the proportion of up to 45% by weight, based on the final mixture, of one or more inorganic filler materials, preferably selected from the group CaCO₃, TiO₂, talc, or chalk, has been admixed with the polyolefin base material.

6. A polyolefin film for the use as claimed in claim 1 or 2, characterized in that the surface treatment took place via corona treatment and/or flame treatment using a substoichiometric-combustion flame.

7. A polyolefin film for the use as claimed in claim 1 or 2, characterized in that the thickness of the film is from 10 to 100 μm.

8. A polyolefin film as claimed in claim 3, characterized in that the film has been coextruded in from two to three layers.

9. A polyolefin film for the use as claimed in claim 1 or 2, characterized in that the film is translucent, with transparency from 10 to 90%.

10. The polyolefin film as claimed in claim 9 and for the use as claimed in claim 1 or 2, characterized in that one or both sides of the film has/have been surface-treated, that one side has been printed with a grid or the like, and only the side opposite to the print has been additionally surface-polarized with a charge.
